(19) United States
(12) Patent Application Publication
(10) Pub. No.: US 2020/0317020 A1
(43) Pub. Date: Oct. 8, 2020

(54) AIR CONDITIONER FOR VEHICLE

(71) Applicant: DENSO CORPORATION, Kariya-city, Aichi-pref (JP)

(72) Inventor: Kenichiro MAEDA, Kariya-city (JP)

(21) Appl. No.: 16/303,996

(22) PCT Filed: Apr. 7, 2017
(86) PCT No.: PCT/JP2017/014558

§ 371 Date: Nov. 21, 2018

(30) Foreign Application Priority Data
May 26, 2016 (JP) 2016-105511

(51) Int. Cl. B60H 1/00; B60H 1/24; B60H 1/34

(52) U.S. Cl. CPC B60H 1/00285; B60H 1/243; B60H 1/00871; B60H 1/00564; B60H 1/34

(57) ABSTRACT

An air conditioner is used in a vehicle that includes a seat configured to be switchable between a first state in which a front end side part of a seat portion is located at a front of the vehicle with respect to a backrest portion, and a second state in which the front end side part of the seat portion is located at a different position from a position of the front end side part in the first state. The vehicle air conditioner includes an air-conditioning unit, and an air outlet configured to blow air from the air-conditioning unit. The vehicle air conditioner also includes a blowing passage member defining a blowing passage that guides the air blown from the air outlet to an upper side of the seat portion when the seat is in the second state.

### CROSS REFERENCE TO RELATED APPLICATION

This application is based on Japanese Patent Application No. 2016-105511 filed on May 26, 2016, the contents of which are incorporated herein by reference in its entirety.

### FIELD OF THE INVENTION

The present disclosure relates to an air conditioner for a vehicle, for blowing air from an air-conditioning unit mounted on the vehicle into a vehicle interior.

### BACKGROUND ART

In some exhibitions, such as the Tokyo Motor Show 2015, a vehicle has been introduced in which front seats, such as a driver's seat and a front passenger's seat, can be oriented toward the rear of the vehicle in an autonomous operation mode, thereby allowing an occupant on the front seat to face another occupant on the rear seat.

On the other hand, a well-known air conditioner for a vehicle is provided with an air outlet for conditioned air, located in an instrument panel of the vehicle, in order to perform air-conditioning of a space where the front seats are mainly disposed. The conditioned air is blown from the air outlet toward an occupant on the front seat (see Patent Document 1).

### RELATED ART DOCUMENT

### [Patent Document]

### [Patent Document 1] Japanese Unexamined Patent Application Publication No. 2012-111318

### SUMMARY OF INVENTION

The air outlet of the air conditioner described in the above-mentioned Patent Document 1 can be applied to a vehicle where the front seats are arranged facing the vehicle rear side. In this case, when the front seat faces the rear of the vehicle, for example, as shown in FIG. 14, a backrest portion 30 of the front seat blocks the air blown from an air outlet 10a of the instrument panel 1 of the vehicle. Consequently, the air conditioner cannot efficiently perform air-conditioning for the occupant on the front seat.

For this reason, for example, as shown in FIG. 15, the inventors have considered a structure including a duct 40 and an air outlet 40a, which are specifically designed to blow the air to the occupant on the front seat when the front seat faces the rear of the vehicle. Such a structure can blow the air toward the occupant via the duct 40 and the air outlet 40a.

However, in this case, as the front seat faces the rear of the vehicle, the air outlet 10a provided in the instrument panel 1 is not completely utilized, thus wasting the conditioned air.

It is an object of the present disclosure to provide an air conditioner for a vehicle which can efficiently perform air-conditioning for an occupant by using a common air outlet either before or after changing the direction of a seat.

According to an aspect of the present disclosure, an air conditioner for a vehicle is for blowing air into a vehicle interior. The air conditioner for a vehicle includes an air outlet configured to blow air from an air-conditioning unit, and a seat having a seat portion on which an occupant sits. The seat is configured to be switchable between a first state in which the occupant sitting on the seat portion faces a front of the vehicle, and a second state in which the occupant faces in a different direction from the front of the vehicle. The air conditioner for a vehicle is provided with a blowing passage member defining a blowing passage that guides the air blown from the air outlet to the occupant sitting on the seat portion when the seat is in the second state.

According to another aspect of the present disclosure, an air conditioner for a vehicle is used for a vehicle that includes a seat configured to be switchable between a first state in which a front end side part of a seat portion is located at a front of the vehicle with respect to a backrest portion, and a second state in which the front end side part of the seat portion is located at a different position from a position of the front end side part in the first state.

The air conditioner for a vehicle includes an air-conditioning unit, an air outlet configured to blow air from the air-conditioning unit; and a blowing passage member that guides the air blown from the air outlet to an upper side of the seat portion when the seat is in the second state.

With this configuration, when the seat is in the second state, the air blown from the air outlet is guided by the blowing passage member to the occupant sitting on the seat portion. Thus, the air conditioning can be efficiently performed for an occupant by using the common air outlet either before or after changing the direction of the seat.

### BRIEF DESCRIPTION OF THE DRAWINGS

FIG. 1 is a schematic view of a vehicle air conditioner according to a first embodiment of the present disclosure, and specifically, a side view of a vehicle in a state where a front seat is arranged in a normal seat layout to face the front of the vehicle;

FIG. 2 is a schematic view of the vehicle air conditioner according to the first embodiment of the present disclosure, and specifically, a side view of the vehicle in a state where the front seat is arranged in a reverse seat layout to face the rear of the vehicle;

FIG. 3 is a schematic top view of the vehicle air conditioner shown in FIG. 2;

FIG. 4 is a schematic view of the vehicle air conditioner according to a second embodiment of the present disclosure, and specifically, a top view of a vehicle in a state where the front seat is arranged in the reverse seat layout;

FIG. 5 is a schematic view of the vehicle air conditioner according to the second embodiment of the present disclosure, and specifically, a side view of the vehicle in a state where the front seat is arranged in the reverse seat layout;

FIG. 6 is a schematic view of a vehicle air conditioner according to a third embodiment of the present disclosure, and specifically, a top view of a vehicle in a state where the front seat is arranged in the reverse seat layout;

FIG. 7 is a schematic view of a vehicle air conditioner according to a fourth embodiment of the present disclosure, and specifically, a top view of a vehicle in a state where the front seat is arranged in the reverse seat layout;

FIG. 8 is a schematic view of a vehicle air conditioner according to a fifth embodiment of the present disclosure, and specifically, a top view of a vehicle in a state where the front seat is arranged in the reverse seat layout;

FIG. 9 is a schematic view of a vehicle air conditioner according to a sixth embodiment of the present disclosure, and specifically, a top view of a vehicle in a state where the front seat is arranged in the reverse seat layout;

FIG. 10 is a schematic view of the vehicle air conditioner according to the sixth embodiment of the present disclosure, and specifically, a side view of the vehicle in a state where the front seat is arranged in the reverse seat layout;

FIG. 11 is a schematic view of a vehicle air conditioner according to a seventh embodiment of the present disclosure, and specifically, a side view of a vehicle in a state where the front seat is arranged in the reverse seat layout;

FIG. 12 is a schematic view of a vehicle air conditioner according to an eighth embodiment of the present disclosure, and specifically, a top view of a vehicle in a state where a driver's seat is arranged in the normal seat layout;

FIG. 13 is a schematic view of a vehicle air conditioner according to the eighth embodiment of the present disclosure, and specifically, a top view of the vehicle in a state where the driver's seat is arranged in a rotation seat layout to be rotated leftward by 90 degrees;

FIG. 14 is a diagram showing a state in which the air blown from an air outlet is blocked by a front seat while the front seat faces the rear of the vehicle;

FIG. 15 is a diagram showing an example of providing a duct, which is specifically designed to blow the air to an occupant on the front seat when the front seat faces the rear of the vehicle; and

FIG. 16 is a schematic view of a vehicle air conditioner according to another embodiment of the present disclosure, and specifically, a side view of a vehicle in a state where the front seat is arranged in the reverse seat layout.

### DESCRIPTION OF EMBODIMENTS

Hereinafter, embodiments of the present disclosure will be described with reference to the accompanying drawings. It is noted that in the respective embodiments below, the same or equivalent parts are indicated by the same reference characters throughout the drawings.

### First Embodiment

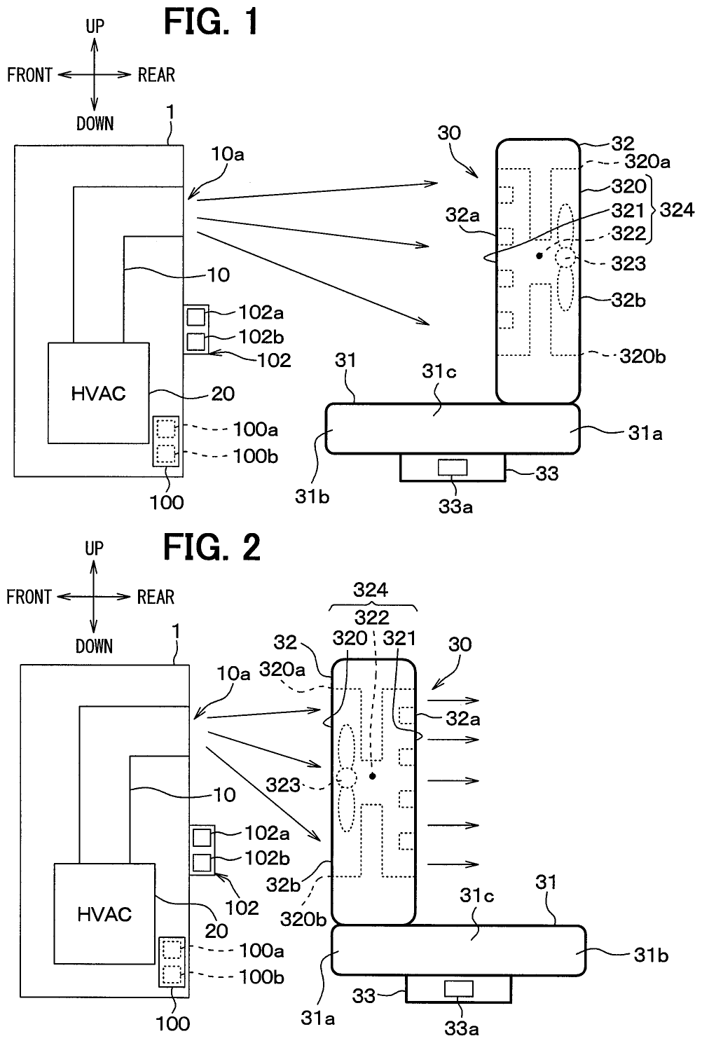

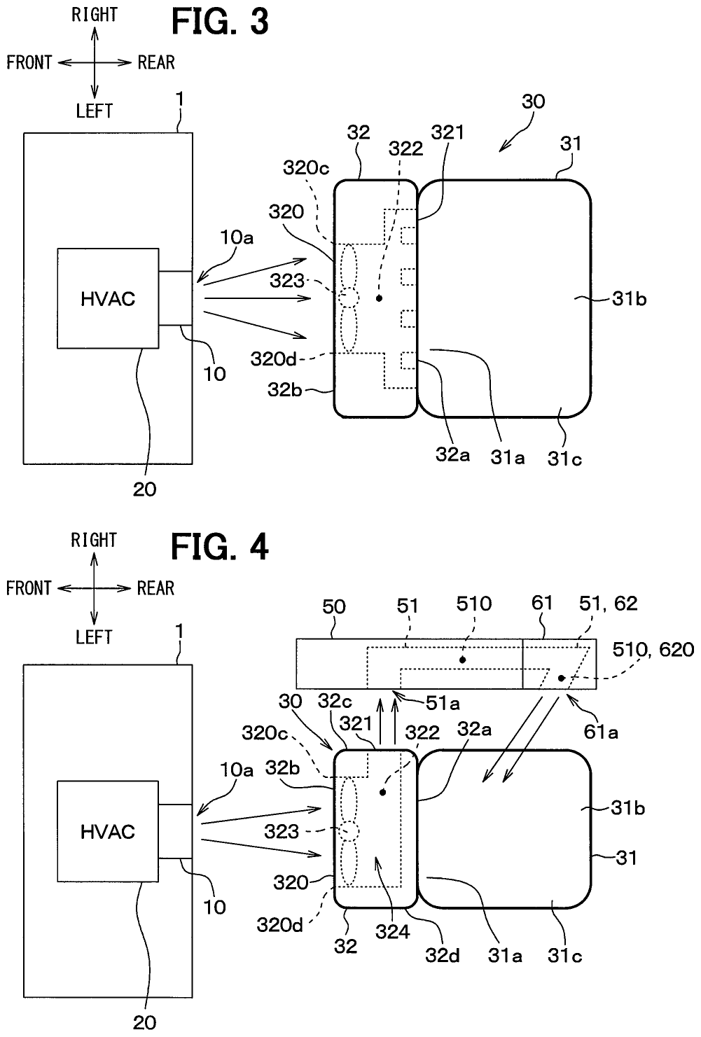

In the following, the configuration of a vehicle air conditioner according to a first embodiment of the present disclosure will be described with reference to FIGS. 1 to 3. FIGS. 1 to 3 are schematic diagrams of the vehicle air conditioner in the present embodiment. FIG. 1 is a schematic side view of a vehicle, showing an example of mounting the vehicle air conditioner on the vehicle in a state where a front seat 30 is arranged in a normal seat layout to face the front of the vehicle. FIG. 2 is a schematic side view of the vehicle, showing an example of mounting the vehicle air conditioner on the vehicle in a state where the front seat 30 is arranged in a reverse seat layout to face the rear of the vehicle. FIG. 3 is a schematic top view of the vehicle, showing an example of mounting the vehicle air conditioner on the vehicle in a state where the front seat 30 is arranged in the reverse seat layout. In the drawings, respective arrows indicative of the up and down, the right and left, and the front and rear represent the up-down direction, the right-left direction, and the front-rear direction, respectively, when the vehicle air conditioner is mounted on the vehicle.

A description will be given on an example in which the vehicle air conditioner of the present embodiment is applied to a vehicle configured to be operable by an autonomous operation system without depending on a driving operation of an occupant. The vehicle air conditioner of the present embodiment includes an air outlet 10a provided in an instrument panel 1 of the vehicle, an air-conditioning unit 20 for blowing air having its temperature adjusted to the air outlet 10a, and the front seat 30.

The air-conditioning unit 20 is also called “HVAC” (which is an abbreviation for heating, ventilation, and air conditioning). The air-conditioning unit 20 is disposed inside the instrument panel 1 at the foremost part of an interior space of the vehicle. The air-conditioning unit 20 includes various air-conditioning devices, such as a blower, an evaporator of a refrigeration cycle, and a heater core, within an air-conditioning case. The air adjusted to a desired temperature by the air-conditioning unit 20 is blown from the air outlet 10a into the vehicle interior via a duct 10 connected to the air-conditioning unit 20. The air-conditioning unit 20 is controlled by an air conditioner ECU 100 described later.

The air outlets for blowing out air from the air-conditioning unit 20 include a face air outlet for blowing out air to the upper body of the occupant in a vehicle cabin, a foot outlet for blowing out air to the lower body of the occupant in the vehicle cabin, a defroster air outlet for blowing out air to the inner surface of a windshield, and the like. In the present embodiment, the face air outlet is described as the air outlet 10a. The air outlet 10a is provided at the front of the vehicle with respect to the front seat 30.

The front seat 30 corresponds to a driver's seat and a passenger's seat. In the present embodiment, the driver's seat will be described as the front seat 30.

The front seat 30 includes a seat portion 31 for supporting the buttocks of the occupant, a backrest portion 32 for supporting the upper body of the occupant, and a seat rotation mechanism 33 for rotating the seat portion 31. The front seat 30 of the present embodiment is configured as a seat air-conditioning unit that blows air from the front side of the front seat 30.

The seat portion 31 has a rear end side part 31a to which the backrest portion 32 is connected, a front end side part 31b located farther away from the backrest portion 32 than the rear end side part 31a, and an intermediate part 31c located between the rear end side part 31a and the front end side part 31b. Specifically, the front end side part 31b is a part for supporting a knee side part of the thigh of the occupant.

A blowing passage member 324 is formed in the backrest portion 32. The blowing passage member 324 has a seat suction port 320 for drawing air into the inside of the backrest portion 32, a seat air outlet 321 for blowing out the air drawn into the inside of the backrest portion 32, and a communication passage 322 for communicating between the seat suction port 320 and the seat air outlet 321.

The seat air outlet 321 is formed on an entire surface 32a of the backrest portion 32, that is, an entire contact surface of the backrest portion 32 that is in contact with the upper body of the occupant. The seat suction port 320 is formed on a back surface 32b of the backrest portion 32, that is, on a surface opposite to the surface 32a of the backrest portion 32. In the present embodiment, the seat suction port 320 corresponds to a first seat opening, and the seat air outlet 321 corresponds to a second seat opening.

The backrest portion 32 is provided with a seat surface material (not shown) having excellent air permeability. That is, a part of the backrest portion 32 exposed to the outside is covered with the seat surface material. Therefore, air is drawn in from the seat suction port 320 through the seat surface material. The air is blown from the seat air outlet 321 through the seat surface material.

A blower fan 323 generates an airflow directing from the seat suction port 320 to the seat air outlet 321 via the communication passage 322. The blower fan 323 is disposed between the seat suction port 320 and the communication passage 322 inside the backrest portion 32. In the present embodiment, the blower fan 323 adopts a centrifugal blower fan having a multi-blade fan. In the blower fan 323, the rotational speed control of the fan, including stopping of the fan, is performed by the air conditioner ECU 100 to be described later.

The front seat 30 is provided with the seat rotation mechanism 33. The front seat 30 can be switched by the seat rotation mechanism 33 between a first state in which the occupant (not shown) sitting on the seat portion 31 faces the front of the vehicle as shown in FIG. 1 and a second state in which the occupant (not shown) sitting on the seat portion 31 faces the rear of the vehicle as shown in FIGS. 2 and 3. In other words, the front seat 30 is switchable between the first state in which the front end side part 31b of the seat portion 31 is located at the front side of the vehicle with respect to the backrest portion 32, and the second state in which the front end side part 31b of the seat portion 31 is located at the rear side of the vehicle with respect to the backrest portion 32.

The seat rotation mechanism 33 is to change the direction of the front seat 30. The seat rotation mechanism 33 is disposed under the seat portion 31. The seat rotation mechanism 33 is provided with a lock 33a for restricting the rotation of the front seat 30. Once the lock 33a of the seat rotation mechanism 33 is released, the front seat 30 is in a state of being capable of changing its direction. The occupant can change the direction of the front seat 30 by releasing the lock 33a provided in the seat rotation mechanism 33 and then rotating the front seat 30. In the present embodiment, the state in which a surface 32a of the backrest portion 32 in the front seat 30 is located at the front of the vehicle with respect to the back surface 32b is referred to as a “normal seat layout”, and the state in which the back surface 32b of the backrest portion 32 in the front seat 30 is located at the front of the vehicle with respect to the surface 32a is referred to as a “reverse seat layout”. In the reverse seat layout, the front end side part 31b of the seat portion 31 in the front seat 30 is in a state of being located at the rear side of the vehicle with respect to the rear end side part 31a.

When the front seat 30 is arranged in the reverse seat layout, the blowing passage member 324 is capable of guiding the air blown from the air outlet 10a to the occupant sitting on the seat portion 31. That is, the seat suction port 320 of the present embodiment is formed in a region including a part that faces the air outlet 10a in the vehicle front-rear direction when the front seat 30 is arranged in the reverse seat layout.

Specifically, as shown in FIG. 2, the seat suction port 320 has such a size that an upper end edge 320a is located above the air outlet 10a, and a lower end edge 320b is located below the air outlet 10a in order to allow the air from the air outlet 10a to easily flow into the seat suction port 320. Furthermore, as shown in FIG. 3, the seat suction port 320 has such a size that a right end edge 320c is located on the right side of the air outlet 10a, and a left end edge 320d is located on the left side of the air outlet 10a in order to allow the air from the air outlet 10a to easily flow into the seat suction port 320.

Next, a description will be given on the air conditioner ECU 100 serving as an electronic control unit for the vehicle air conditioner. The air conditioner ECU 100 includes a well-known microcomputer having a processor and a storage unit, and its peripheral circuit.

The air conditioner ECU 100 has its input side connected to a sensor group for detecting an outside air temperature, an inside air temperature, and the like, the seat rotation mechanism 33, an operating portion 102 provided on the instrument panel 1, and the like. The air conditioner ECU 100 of the present embodiment is capable of detecting the front seat 30 arranged in the reverse seat layout by the seat rotation mechanism 33 (i.e., in the second state). The component of the air conditioner ECU 100 that detects the front seat 30 arranged in the reverse seat layout (i.e., in the second state) configures a state detector 100a.

The air conditioner ECU 100 has its output side connected to control target devices, such as the air-conditioning unit 20 and the blower fan 323. The air conditioner ECU 100 controls the air-conditioning unit 20 and the blower fan 323 in accordance with control programs stored in the storage portion. The component for controlling the air-conditioning unit 20 in the air conditioner ECU 100 configures an air-conditioning controller 100b.

Next, the operation of the vehicle air conditioner in the present embodiment will be described. The air-conditioning unit 20 starts its operation when an air-conditioning operation switch 102a provided in the operating portion 102 is turned on. Then, the temperature-adjusted air is blown from the air-conditioning unit 20 through the air outlet 10a provided in the instrument panel 1. In other words, when the air-conditioning operation switch 102a is turned on, the air conditioner ECU 100 controls the air-conditioning unit 20 such that the temperature-adjusted air is blown from the air outlet 10a.

In the front seat 30 as the seat air-conditioning unit, the blower fan 323 starts its operation when a seat operation switch 102b in the operating portion 102 is turned on. Then, the air is blown by the blower fan 323 from the seat air outlet 321 formed on the surface 32a of the backrest portion 32 in the front seat 30. In other words, when the seat operation switch 102b is turned on, the air conditioner ECU 100 controls the blower fan 323 so as to blow the air from the seat air outlet 321.

Here, as shown in FIG. 1, when the front seat 30 is arranged in the normal seat layout, the conditioned air generated by the air-conditioning unit 20 is directly blown from the air outlet 10a provided in the instrument panel 1 toward the occupant sitting on the front seat 30.

Further, air is drawn from the seat suction port 320 provided on the back surface 32b of the backrest portion 32 by the blower fan 323 disposed within the backrest portion 32 of the front seat 30. Subsequently, the air drawn from the seat suction port 320 is blown from the seat air outlet 321 provided on the surface 32a of the backrest portion 32 toward the occupant sitting on the front seat 30 via the communication passage 322.

On the other hand, as shown in FIGS. 2 and 3, when the front seat 30 is arranged in the reverse seat layout, the conditioned air generated by the air-conditioning unit 20 is blown from the air outlet 10a provided in the instrument panel 1 toward the back surface 32b of the backrest portion 32 in the front seat 30.

Subsequently, the air blown toward the back surface 32b of the backrest portion 32 in the front seat 30 is drawn from the seat suction port 320 provided on the back surface 32b of the backrest portion 32 by the blower fan 323 disposed within the backrest portion 32 of the front seat 30. The air drawn from the seat suction port 320 is blown from the seat air outlet 321 provided on the surface 32a of the backrest portion 32 toward the occupant sitting on the front seat 30 through the communication passage 322.

Here, when the front seat 30 is detected to be arranged in the reverse seat layout, the air conditioner ECU 100 controls the air-conditioning unit 20 to guide the air blown from the air outlet 10a toward the upper side of the seat portion 31 via the blowing passage member 324. That is, when the front seat 30 is detected to be arranged in the reverse seat layout, the air conditioner ECU 100 controls the air-conditioning unit 20 to guide the air blown from the air outlet 10a toward the occupant sitting on the front seat 30 via the blowing passage member 324. The air conditioner ECU 100 controls the air-conditioning unit 20 to blow the air from the face air outlet facing the seat suction port 320, among the face air outlet, the foot air outlet, and the defroster air outlet, for example, when the front seat 30 is arranged in the reverse seat layout.

In this way, in both the normal seat layout and the reverse seat layout, the conditioned air can be supplied to the occupant on the front seat 30 by using the common air outlet 10a provided in the instrument panel 1.

As described above, the vehicle air conditioner in the present embodiment has the air outlet 10a for blowing air from the air-conditioning unit 20. In addition, the vehicle air conditioner further includes the front seat 30 that has the seat portion 31 on which an occupant sits. The front seat 30 can be switched between the first state in which the occupant sitting on the seat portion 31 faces the front of the vehicle and the second state in which the occupant sitting on the seat portion 31 faces the rear of the vehicle. Furthermore, when the front seat 30 is arranged in the reverse seat layout, the vehicle air conditioner includes the blowing passage member 324 that defines a blowing passage for guiding the air blown from the air outlet 10a to the occupant sitting on the seat portion 31.

Thus, when the front seat 30 is arranged in the reverse seat layout, the air blown from the air outlet 10a is guided by the blowing passage member 324 to the occupant sitting on the seat portion 31. Thus, the air conditioner for a vehicle can efficiently perform air-conditioning for the occupant by using the common air outlet 10a either before or after changing the direction of the front seat 30.

The front seat 30 includes the backrest portion 32 for supporting the upper body of the occupant. The blowing passage member 324 of the present embodiment has the seat suction port 320 provided in the back surface 32b of the backrest portion 32, and the seat air outlet 321 provided at a position different from the seat suction port 320 in the backrest portion 32. The blowing passage member 324 of the present embodiment also has the communication passage 322 formed inside the backrest portion 32 to communicate between the seat suction port 320 and the seat air outlet 321.

Thus, even when the front seat 30 is arranged in the reverse seat layout, the conditioned air blown from the air outlet 10a can be supplied to the occupant sitting on the front seat 30 via the seat suction port 320, the seat air outlet 321, and the communication passage 322.

The seat air outlet 321 is provided at the surface 32a of the backrest portion 32, so that the air blown from the air outlet 10a can be blown toward the back of the occupant.

### Second Embodiment

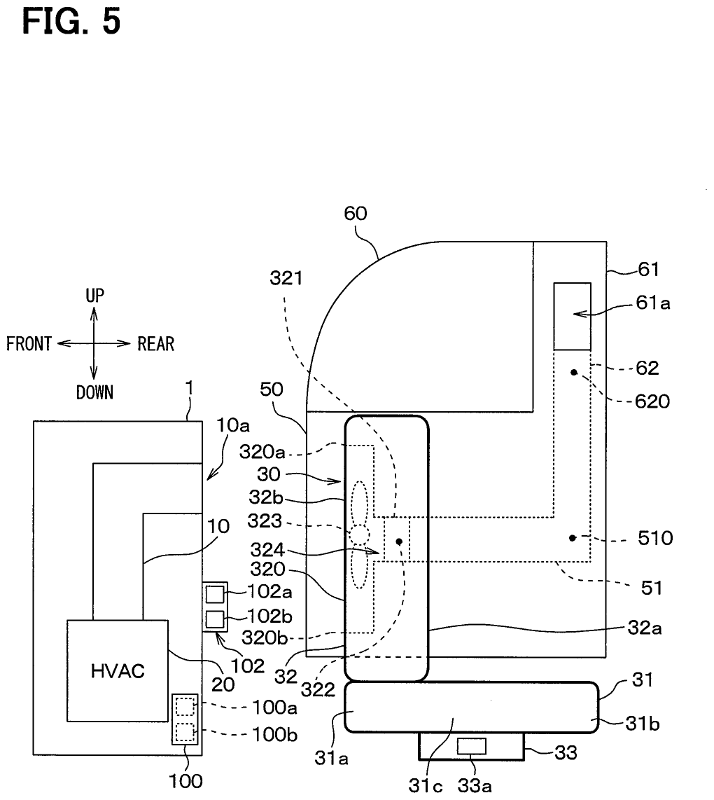

Hereinafter, the configuration of a vehicle air conditioner according to a second embodiment of the present disclosure will be described with reference to FIGS. 4 and 5. FIG. 4 is a top view showing an example of mounting the vehicle air conditioner on the vehicle in a state where the front seat 30 is arranged in the reverse seat layout. FIG. 5 is a vehicle side view of the vehicle in a state where the front seat 30 is arranged in the reverse seat layout.

In the description of the above-mentioned first embodiment by way of example, when the front seat 30 is arranged in the reverse seat layout to face the rear of the vehicle, the air blown from the air outlet 10a is guided to the occupant via the blowing passage member 324 formed in the front seat 30.

On the other hand, the air conditioner for a vehicle in the present embodiment includes a first blowing passage member 324 provided in the front seat 30, and second blowing passage members 51 and 62 provided in vehicle interior components different from the front seat 30. That is, the vehicle air conditioner in the present embodiment is configured to guide the air blown from the air outlet 10a to the occupant via the first blowing passage member 324 and the second blowing passage members 51 and 62 when the front seat 30 is arranged in the reverse seat layout to face the rear of the vehicle.

The first blowing passage member 324 is provided in the front seat 30. Specifically, the first blowing passage member 324 has the seat suction port 320 provided in the back surface 32b of the backrest portion 32, the seat air outlet 321 provided in the surface, on a side of a front door 50, of the backrest portion 32, and the first communication passage 322.

The seat air outlet 321 of the present embodiment is provided on a side surface 32c facing the front door 50, among the side surfaces 32c and 32d that connect the surface 32a and the back surface 32b of the backrest portion 32, when the front seat 30 is arranged in the reverse seat layout. Specifically, the seat air outlet 321 is provided in a part of the side surface 32c of the backrest portion 32 facing the front door 50 in the right-left direction.

The first communication passage 322 communicates between the seat suction port 320 and the seat air outlet 321. The first communication passage 322 is formed in an L-shape such that the side of the seat suction port 320 extends in the front-rear direction while the side of the seat air outlet 321 extends in the right-left direction within the backrest portion 32.

The vehicle interior components different from the front seat 30 of the present embodiment correspond to the front door 50 and a center pillar 61 for the occupant to get on and off the vehicle. A window 60 of the vehicle shown in FIG. 5 is configured to be stored inside the front door 50 by an actuator (not shown).

The second blowing passage members 51 and 62 include a door passage member 51 formed in the front door 50 and a center pillar passage member 62 formed in the center pillar 61 of the vehicle. A blowing passage 510 is defined by the door passage member 51 within the front door 50. A blowing passage 620 is defined by the center pillar passage member 62 within the center pillar 61. Hereinafter, the respective blowing passages 510 and 620 may be collectively referred to as a second communication passage.

The front door 50 is a door corresponding to the front seat 30. That is, the front door 50 is a door that is adjacent to the front seat 30 and is opened and closed when the occupant gets on and off the vehicle. The front door 50 corresponding to the front seat 30 is a door facing the side surface 32c of the backrest portion 32 in the front seat 30. Among the front doors 50, for example, a driver's seat door corresponds to the driver's seat, and a passenger's seat door corresponds to the passenger's seat.

One end of the door passage member 51 is coupled to one end of the center pillar passage member 62. The door passage member 51 is configured such that an opening thereof at the side of one end is connected to an opening at the side of one end of the center pillar passage member 62 when the front door 50 is closed. The opening at the side of one end of the door passage member 51 is formed at a part of the front door 50 facing the center pillar 61 when the front door 50 is closed.

A first opening 51a is formed at the other end of the door passage member 51. The first opening 51a is formed to face the seat air outlet 321 in the front-rear direction and right-left direction in the reverse seat layout. Thus, the door passage member 51 is configured such that the air blown from the seat air outlet 321 flows into the door passage member 51 via the first opening 51a in the reverse seat layout.

The center pillar passage member 62 is configured such that an opening thereof at the side of one end thereof is connected to an opening at the side of one end of the door passage member 51 when the front door 50 is closed. The opening at the side of one end of the center pillar passage member 62 is formed at a part of the center pillar 61 facing the opening of the front door 50 when the front door 50 is closed.

A second opening 61a is formed at the other end of the center pillar passage member 62. The second opening 61a is formed in the center pillar 61 of the vehicle. The second opening 61a is formed in at least a part of the center pillar 61 located above the seat portion 31 in the reverse seat layout.

In the center pillar passage member 62, a part of the blowing passage 620 on the side of the second opening 61a extends toward the side of the backrest portion 32 such that the air blown from the second opening 61a is directed toward the side of the backrest portion 32 in the reverse seat layout. Thus, the center pillar passage member 62 is configured such that the air from the second opening 61a is blown out toward the occupant sitting on the front seat 30 in the reverse seat layout.

In this way, the second blowing passage members 51 and 62 have the first opening 51a provided in the vehicle interior component different from the front seat 30, and the second opening 61a provided in a different position from the first opening 51a, respectively. Specifically, the second blowing passage members 51 and 62 include the door passage member 51 formed in the front door 50 and the center pillar passage member 62 formed in the center pillar 61 of the vehicle, respectively.

The second blowing passage members 51 and 62 further have the second communication passages 510 and 620 that communicate between the first opening 51a and the second opening 61a formed within the vehicle interior components. When the front seat 30 is arranged in the reverse seat layout, the air blown from the air outlet 10a is guided to the occupant via the first blowing passage member 324 provided in the front seat 30, the door passage member 51, and the center pillar passage member 62.

In the present embodiment, the seat air outlet 321 provided in the front seat 30 and the first opening 51a of the door passage member 51 are configured to be in proximity to each other when the front seat 30 is arranged in the reverse seat layout.

With the above-mentioned configuration, in the normal seat layout, although not shown, the conditioned air generated by the air-conditioning unit 20 is directly blown from the air outlet 10a provided in the instrument panel 1 toward the occupant sitting on the front seat 30, like the first embodiment.

In the reverse seat layout, the conditioned air generated by the air-conditioning unit 20 is blown from the air outlet 10a provided in the instrument panel 1 toward the back surface 32b of the backrest portion 32 in the front seat 30.

Subsequently, the air blown toward the back surface 32b of the backrest portion 32 in the front seat 30 is drawn from the seat suction port 320 by the blower fan 323. The air drawn from the seat suction port 320 is blown from the seat air outlet 321 provided in the surface, on the side of the front door 50, of the backrest portion 32 through the communication passage 322.

The air blown from the seat air outlet 321 is blown from the second opening 61a formed in the center pillar 61 toward the occupant sitting on the front seat 30 through the door passage member 51 and the center pillar passage member 62.

In the present embodiment, the effects exhibited by the same structure as that in the first embodiment can be obtained in the same manner as the first embodiment.

Not only in the normal seat layout, but also in the reverse seat layout, the air can be blown from the oblique front of the occupant toward the upper body of the occupant.

### Third Embodiment

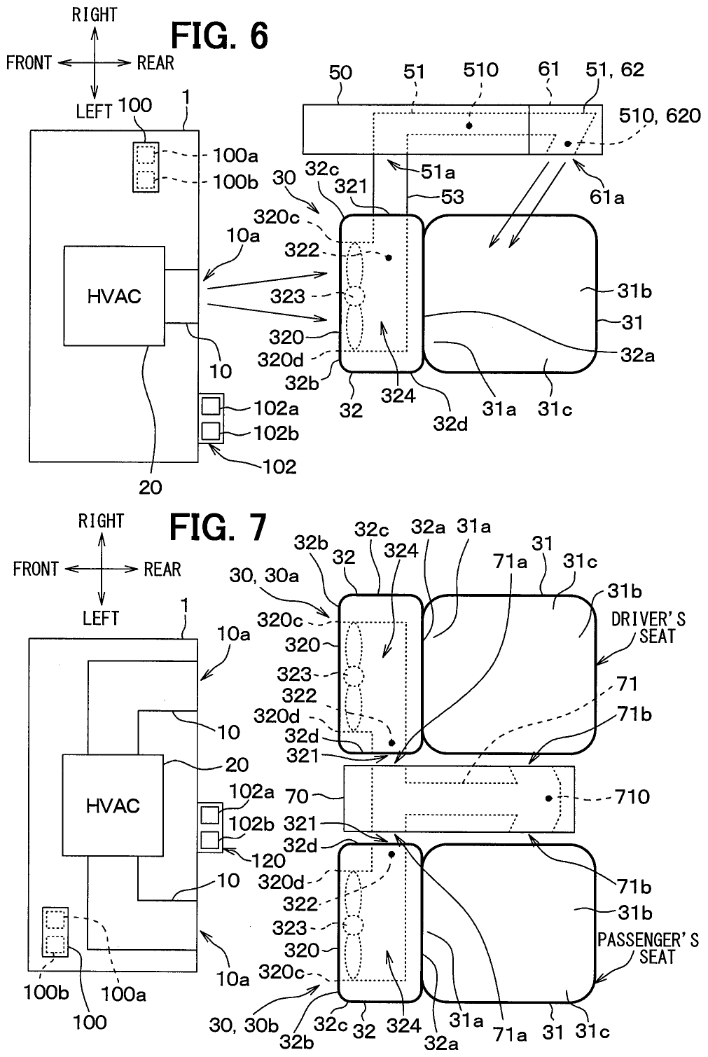

Hereinafter, the configuration of a vehicle air conditioner according to a third embodiment of the present disclosure will be described with reference to FIG. 6. FIG. 6 is a top view of the vehicle air conditioner in a state where the front seat 30 is arranged in the reverse seat layout.

In the description of the second embodiment by way of example, the seat air outlet 321 provided in the front seat 30 and the first opening 51a provided in the door passage member 51 are configured to be in proximity to each other when the front seat 30 is arranged in the reverse seat layout.

On the other hand, the vehicle air conditioner of the present embodiment includes a coupling member 53 that couples between the seat air outlet 321 provided in the front seat 30 and the first opening 51a of the door passage member 51 when the front seat 30 is arranged in the reverse seat layout. The coupling member 53 configures the blowing passage member.

The coupling member 53 is configured of a cylindrical material that has, at the side of one end thereof, an opening surrounding the seat air outlet 321. The coupling member 53 of the present embodiment is fixed to a part of the backrest portion 32 where the seat air outlet 321 is formed.

The coupling member 53 is protruded outward from the backrest portion 32 such that the opening at the side of the other end of the coupling member overlaps with the first opening 51a of the door passage member 51 when the front seat 30 is arranged in the reverse seat layout. Thus, when the front seat 30 is switched from the normal seat layout to the reverse seat layout, the seat air outlet 321 and the first opening 51a of the door passage member 51 are coupled together with the coupling member 53.

When the front seat 30 is switched from the reverse seat layout to the normal seat layout, the coupling member 53 is displaced to a position where the opening at the side of the other end of the coupling member 53 does not face the first opening 51a of the door passage member 51 by rotation of the front seat 30. In this way, the coupling between the seat air outlet 321 and the first opening 51a of the door passage member 51 is released.

Here, the coupling member 53 is desirably configured such that at least a part of the coupling member 53 can expand and contract in the direction of extension of the cylindrical axis thereof in order to suppress interference with surrounding members, such as the front door 50, when rotating the front seat 30.

In the present embodiment, the effects exhibited by the same structure as that in the second embodiment can be obtained in the same manner as the second embodiment.

When the front seat 30 is arranged in the reverse seat layout, the whole air blown from the seat air outlet 321 of the first blowing passage member 324 can be caused to flow into the first opening 51a of the door passage member 51 by the above-mentioned coupling member 53.

In the description of the present embodiment by way of example, the coupling member 53 is fixed to the part of the backrest portion 32 where the seat air outlet 321 is formed. However, the coupling member 53 is not limited thereto. The coupling member 53 may be fixed, for example, to a part of the front door 50 where the first opening 51a of the door passage member 51 is formed.

### Fourth Embodiment

Hereinafter, the configuration of a vehicle air conditioner according to a fourth embodiment of the present disclosure will be described with reference to FIG. 7. FIG. 7 is a top view of the vehicle air conditioner in a state where the front seat 30 is arranged in the reverse seat layout. As shown in FIG. 7, the front seats 30 include both a driver's seat 30a and a passenger's seat 30b.

In the description of the above-mentioned second embodiment by way of example, the air blown from the air outlet 10a is guided to the occupant via the first blowing passage member 324 formed in the front seat 30, and the second blowing passage members 51 and 62 formed in the front door 50 and the center pillar 61, respectively.

On the other hand, the vehicle air conditioner of the present embodiment is configured to guide the air from the air outlets 10a to the occupant via the first blowing passage members 324 formed in the front seats 30 and a console passage member 71 formed in a center console 70 of the vehicle. The center console 70 is disposed between the driver's seat 30a and the passenger's seat 30b.

The seat air outlets 321 in the front seats 30 of the present embodiment are provided in the respective surfaces facing the sides of the center console 70 when the front seat 30 is arranged in the reverse seat layout. Each seat air outlet 321 of the present embodiment is provided at the side surface 32d facing the center console 70 when the front seat 30 is arranged in the reverse seat layout. Specifically, each seat air outlet 321 is provided in a part of the side surface 32d of the backrest portion 32 facing the center console 70 in the right-left direction.

The console passage member 71 has first openings 71a, second openings 71b formed at the rear of the vehicle with respect to the first openings 71a, and a communication passage 710 that communicates between the first openings 71a and the second openings 71b.

Each first opening 71a is formed in the position of the center console 70 that is in proximity to the seat air outlet 321 of the front seat 30 when the front seat 30 is arranged in the reverse seat layout. Specifically, the first opening 71a is formed at a part facing the seat air outlet 321 in the front-rear direction and right-left direction in the reverse seat layout. Thus, the console passage member 71 is configured such that the air blown from the seat air outlets 321 flows into the console passage member 71 via the first openings 71a in the reverse seat layout.

Each second opening 71b is formed in at least a part of the center console 70 located above the seat portion 31 in the reverse seat layout.

In the console passage member 71, a part of the communication passage 710 on the side of each second opening 71b extends toward the side of the backrest portion 32 such that the air blown from the second opening 71b is directed toward the side of the backrest portion 32 in the reverse seat layout. Thus, the console passage member 71 is configured such that the air blown from each second opening 71b is blown out toward the occupant sitting on the corresponding front seat 30 in the reverse seat layout.

With the above-mentioned configuration, in the normal seat layout, although not shown, the conditioned air generated by the air-conditioning unit 20 is directly blown from the air outlet 10a provided in the instrument panel 1 toward the occupant sitting on the front seat 30, like the above-mentioned first embodiment.

On the other hand, in the reverse seat layout, the conditioned air generated by the air-conditioning unit 20 is blown from the air outlet 10a provided in the instrument panel 1 toward the back surfaces 32b of the backrest portion 32 in the front seats 30.

Subsequently, the air blown toward the back surfaces 32b of the backrest portions 32 in the front seats 30 is drawn from the seat suction ports 320 by the blower fans 323. The air drawn from the seat suction ports 320 is blown from each seat air outlet 321 provided in the surface on each side of the center console 70 through the corresponding communication passage 322.

The air blown from the seat air outlets 321 is blown from each second opening 71b formed in the console passage member 71 toward the corresponding occupant sitting on the front seat 30 through the console passage member 71.

In the present embodiment, the effects exhibited by the same structure as that in the second embodiment can be obtained in the same manner as the second embodiment.

### Fifth Embodiment

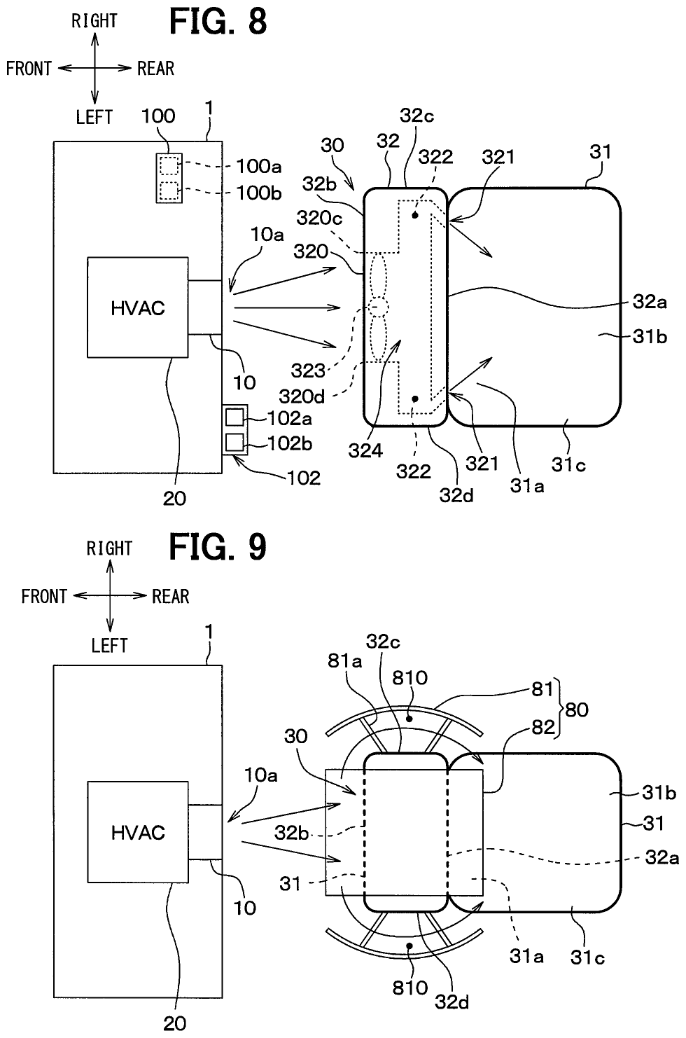

Hereinafter, the configuration of a vehicle air conditioner according to a fifth embodiment of the present disclosure will be described with reference to FIG. 8. FIG. 8 is a top view of the vehicle air conditioner in a state where the front seat 30 is arranged in the reverse seat layout.

In the description of the first embodiment by way of example, the seat air outlet 321 is formed over the entire surface 32a of the backrest portion 32.

On the other hand, the seat air outlet 321 of the present embodiment is provided not over the entire surface 32a of the backrest portion 32, but at the side of each end in the vehicle width direction (i.e., right-left direction) of the surface 32a of the backrest portion 32.

The seat air outlets 321 are provided at the respective parts on which a load acting on the backrest portion 32 is less than that on the substantially center part of the backrest portion 32 when the occupant sits on the seat. Specifically, the seat air outlets 321 are provided at the parts of the backrest portion 32 in more proximity to the side surfaces 32c and 32d than the substantially center part of the backrest portion 32 in the right-left direction. The seat air outlets 321 are formed, for example, on a pair of side supports provided on both sides of a lumbar support portion for supporting the lumbar of the occupant.

Thus, in the vehicle air conditioner of the present embodiment, the seat air outlets 321 are provided on both ends in the vehicle width direction on the surface 32a of the backrest portion 32, thus making it possible to prevent the seat air outlets 321 from being covered with the body of the occupant.

In the present embodiment, the effects exhibited by the same structure as that in the first embodiment can be obtained in the same manner as the first embodiment.

### Sixth Embodiment

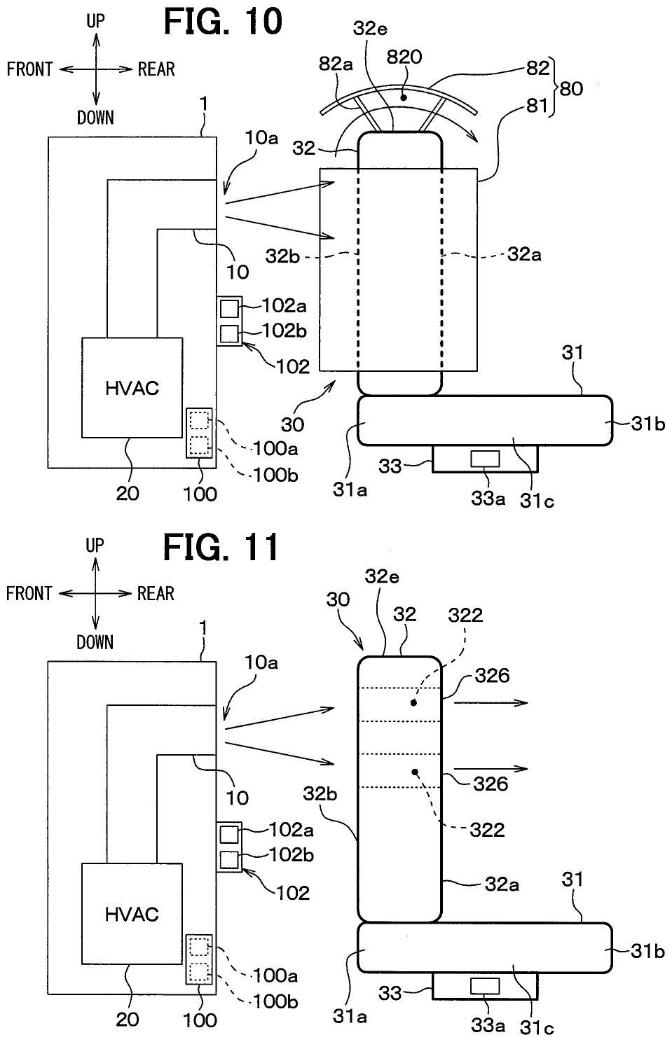

Hereinafter, the configuration of a vehicle air conditioner according to a fifth embodiment of the present disclosure will be described with reference to FIGS. 9 and 10. FIG. 9 is a top view of the vehicle air conditioner in a state where the front seat 30 is arranged in the reverse seat layout. FIG. 10 is a vehicle side view in a state where the front seat 30 is arranged in the reverse seat layout.

In the description of the above-mentioned respective embodiments by way of example, the blowing passage member 324 is formed within the backrest portion 32 of the front seat 30, and by using the blowing passage member 324, the air blown from the air outlet 10a is blown toward the occupant in the reverse seat layout.

In contrast, the vehicle air conditioner of the present embodiment includes a guide 80 that guides the air blown from the air outlet 10a to the occupant such that the air flows bypassing the backrest portion 32 in the front seat 30 from the back surface 32b of the backrest portion 32 to the surface 32a thereof in the reverse seat layout. In the present embodiment, the guide 80 configures a ventilation passage member.

The guide 80 includes side surface guides 81 provided on the side surfaces 32c and 32d of the backrest portion 32 in the front seat 30, and an upper surface guide 82 provided at an upper surface 32e of the backrest portion 32.

The side surface guides 81 and the upper surface guide 82 each are formed in a thin-plate shape, and made of resin or metal. Each of the side surface guides 81 and the upper surface guide 82 has a shape curved in a substantially arc shape.

The side surface guides 81 have support portions 81a, and are attached to the side surfaces 32c and 32d of the backrest portion 32 via the support portions 81a. A blowing passage 810 is defined between each side surface guide 81 and the backrest portion 32.

As shown in FIG. 9, the side surface guides 81 are disposed to overlap with the side surfaces 32c and 32d of the backrest portion 32 in the right-left direction. Each of the side surface guides 81 has such a substantially arc, curved shape that both ends in the front-rear direction of the side surface guide 81 are positioned toward the side of the backrest portion 32 in the right-left direction, compared to the substantially center part in the front-rear direction of the side surface guide 81. The side surface guide 81 has its length in the front-rear direction larger than the thickness of the backrest portion 32. The side surface guide 81 is disposed with a predetermined spacing from each of the side surfaces 32c and 32d of the backrest portion 32 in the right-left direction. With this configuration, the blowing passage 810 curved in the substantially arc shape is defined between the corresponding side surface guide 81 and each of the side surfaces 32c and 32d of the backrest portion 32 such that the air bypasses the backrest portion 32 from the side of the back surface 32b of the backrest portion 32 toward the surface 32a.

The upper surface guide 82 has support portions 82a, and is attached to the upper surface 32e of the backrest portion 32 via the support portions 82a. A blowing passage 820 is defined between the upper surface guide 82 and the backrest portion 32.

As shown in FIG. 10, the upper surface guide 82 is disposed to overlap with the upper surface 32e of the backrest portion 32 in the up-down direction. The upper surface guide 82 has such a substantially arc, curved shape that both ends in the front-rear direction of the upper surface guide 82 are located on the side of the backrest portion 32 in the up-down direction with respect to the substantially center part in the front-rear direction of the upper surface guide 82. The upper surface guide 82 has its length in the front-rear direction larger than the thickness of the backrest portion 32. The upper surface guide 82 is disposed with a predetermined spacing from the upper surface 32e of the backrest portion 32 in the up-down direction. With this configuration, the blowing passage 820 curved in the substantially arc shape is defined between the upper surface guide 82 and the upper surface 32e of the backrest portion 32 such that the air bypasses the backrest portion 32 from the side of the back surface 32b of the backrest portion 32 to the side of the surface 32a thereof.

In the above-mentioned configuration, in the normal seat layout, although not shown, the conditioned air generated by the air-conditioning unit 20 is blown from the air outlet 10a provided in the instrument panel 1 directly toward the occupant sitting on the front seat 30, like the first embodiment.

In the reverse seat layout, the conditioned air generated by the air-conditioning unit 20 is blown from the air outlet 10a provided in the instrument panel 1 toward the back surface 32b of the backrest portion 32 in the front seat 30.

The air blown toward the back surface 32b of the backrest portion 32 in the front seat 30 is guided to the occupant by the side surface guides 81 and the upper surface guide 82 so as to flow bypassing the backrest portion 32 from the back surface 32b of the backrest portion 32 to the surface 32a of the front seat 30.

In the present embodiment, the effects exhibited by the same structure as that in the first embodiment can be obtained in the same manner as the first embodiment.

In the vehicle air conditioner of the present embodiment, in the reverse seat layout, the air blown from the air outlet 10a is guided to the occupant by the guide 80 including the side surface guides 81 and the upper surface guide 82, thereby making it possible to efficiently perform air-conditioning for the occupant with the simple configuration.

### Seventh Embodiment

Hereinafter, the configuration of a vehicle air conditioner according to a seventh embodiment of the present disclosure will be described with reference to FIG. 11. FIG. 11 is a side view of the vehicle in a state where the front seat 30 is arranged in the reverse seat layout.

In the description of the first embodiment by way of example, the seat air-conditioning unit for blowing the air from the front side of the seat is configured in the front seat 30.

On the other hand, the vehicle air conditioner of the present embodiment has through holes 326 as the blowing passage member 324 inside the backrest portion 32 of the front seat 30, and is configured to blow the air from the air outlet 10a toward the occupant via the through holes 326 in the reverse seat layout.

The backrest portion 32 has the through holes 326 passing through the surface 32a and the back surface 32b of the backrest portion 32. The communication passages 322 are formed by the through holes 326 in the backrest portion 32.

The through holes 326 are formed in a region that includes a part facing the air outlet 10a in the front-rear direction so as to cause the air from the air outlet 10a to easily flow into the through holes, when the front seat 30 is arranged in the reverse seat layout.

In the reverse seat layout, the conditioned air generated by the air-conditioning unit 20 is blown from the air outlet 10a provided in the instrument panel 1 toward the back surface 32b of the backrest portion 32 in the front seat 30. Subsequently, the air blown toward the back surface 32b of the backrest portion 32 in the front seat 30 is guided to the occupant through the communication passages 322 formed by the through holes 326.

In the present embodiment, the effects exhibited by the same structure as that in the first embodiment can be obtained in the same manner as the first embodiment.

The vehicle air conditioner of the present embodiment can guide the air to the occupant with the simple configuration, compared to the case where the seat air-conditioning unit is configured in the front seat 30.

### Eighth Embodiment

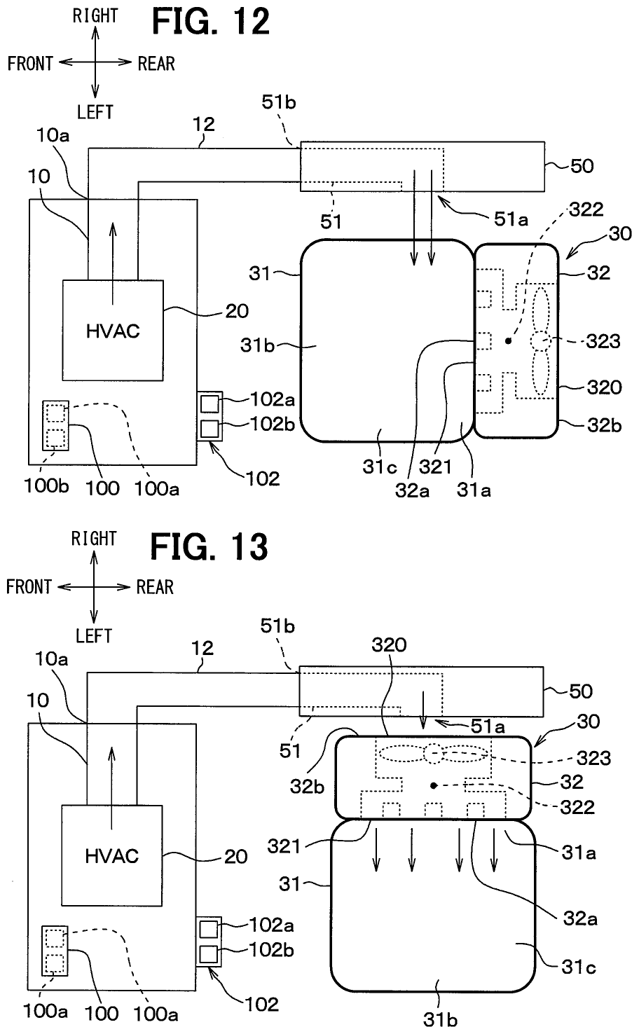

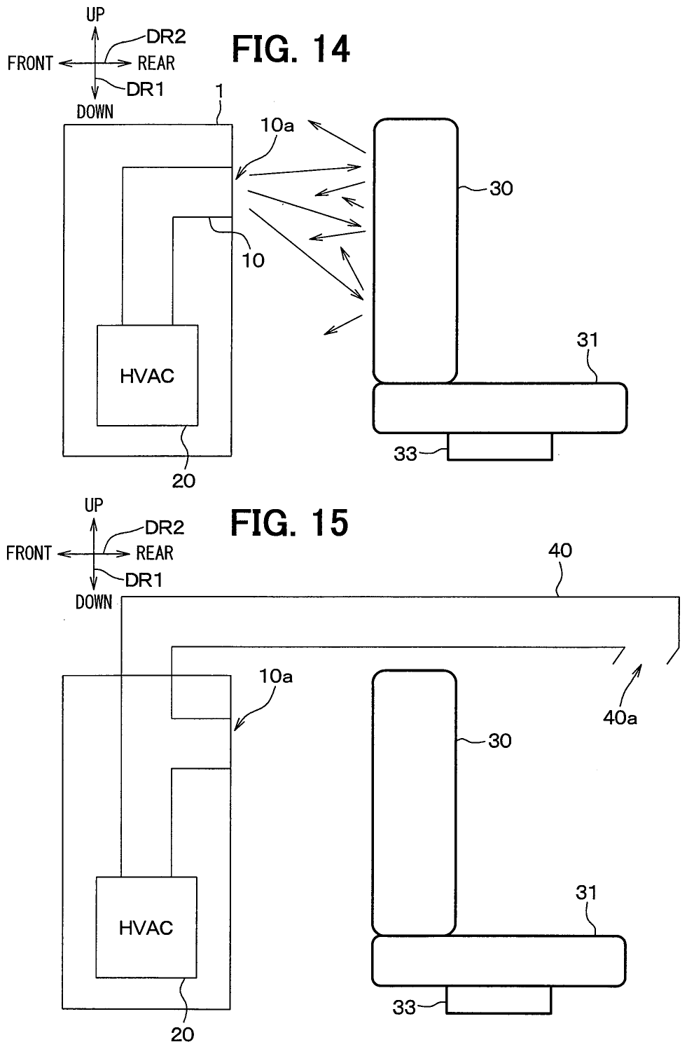

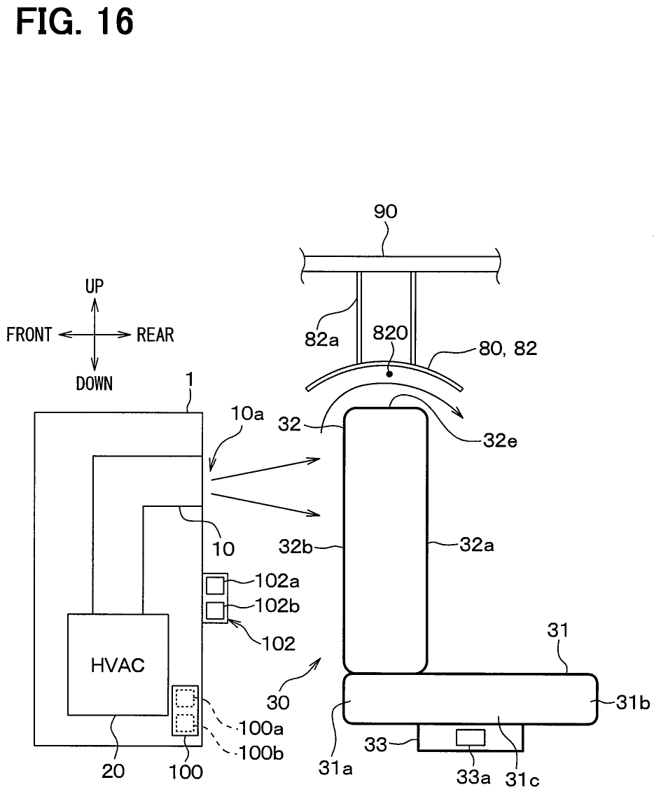

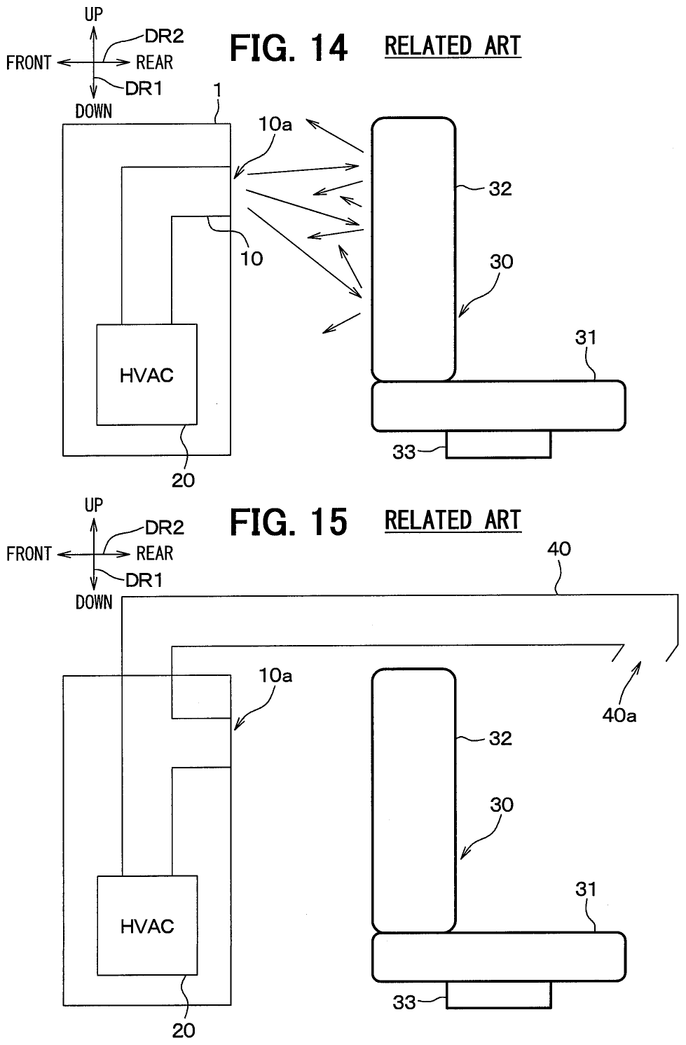

Hereinafter, the configuration of a vehicle air conditioner according to an eighth embodiment of the present disclosure will be described with reference to FIGS. 12 and 13. FIG. 12 is a top view of the vehicle air conditioner in a state where the driver's seat 30 is arranged in the normal seat layout. FIG. 13 is a top view of the vehicle air conditioner in a state where the driver's seat 30 is arranged in a rotated seat layout in which the driver's seat 30 is rotated leftward by 90 degrees. The present embodiment will describe an example in which the vehicle air-conditioner is applied to a vehicle that can be set to arrange the driver's seat 30 in the normal seat layout as shown in FIG. 12 and also to arrange the driver's seat 30 in the rotated seat layout where the driver's seat 30 is rotated counterclockwise by 90 degrees as shown in FIG. 13.

In the description of the second embodiment by way of example, the air blown from the air outlet 10a is guided to the occupant from the second opening 61a of the center pillar passage member 62 via the blowing passage member 324 of the front seat 30, the door passage member 51, and the center pillar passage member 62.

On the other hand, the vehicle air conditioner of the present embodiment includes a door blowing ventilation member 12 that introduces the air blown from the air-conditioning unit 20 into the door passage member 51. The vehicle air conditioner of the present embodiment is configured to blow the air, which has been blown from the door blowing ventilation member 12, from the first opening 51a of the door passage member 51 to the occupant via the door passage member 51.

The door blowing ventilation member 12 is a cylindrical material that introduces the air blown from the air outlet 10a of the air-conditioning unit 20 to the door passage member 51 disposed in the front door 50. The door blowing ventilation member 12 has one end thereof connected to the air outlet 10a of the air-conditioning unit 20 and the other end thereof connected to an introduction side opening 51b in the door passage member 51.

The door passage member 51 of the present embodiment is configured of a cylindrical member that has the first opening 51a and the introduction side opening 51b. As mentioned above, the introduction side opening 51b is connected to the other end side of the door blowing ventilation member 12.

The first opening 51a of the present embodiment is provided in a part of the front door 50 that faces the occupant sitting on the driver's seat 30 in the normal seat layout and also faces the seat suction port 320 of the backrest portion 32 in the rotated seat layout. Specifically, the first opening 51a is provided in the part of the front door 50 that faces a space on the upper side of the seat portion 31 and on the front side of the backrest portion 32 in the normal seat layout, and also faces the seat suction port 320 in the rotated seat layout.

In the present embodiment, in the normal seat layout, the air is blown from the first opening 51a provided on the side of the occupant. That is, in the normal seat layout, the conditioned air generated by the air-conditioning unit 20 flows from the air outlet 10a into the door blowing ventilation member 12. Subsequently, the air flowing into the door blowing ventilation member 12 is blown from the first opening 51a to the occupant via the door passage member 51.

In the rotated seat layout, the air is blown from the first opening 51a of the door passage member 51 toward the back surface 32b of the backrest portion 32 in the front seat 30. That is, in the rotated seat layout, the conditioned air generated by the air-conditioning unit 20 flows from the air outlet 10a into the door blowing ventilation member 12. Subsequently, the air flowing into the door blowing ventilation member 12 is blown from the first opening 51a via the door passage member 51.

The air blown toward the back surface 32b of the backrest portion 32 in the front seat 30 is drawn from the seat suction port 320 by the blower fan 323, and then blown from the seat air outlet 321 provided in the surface 32a of the backrest portion 32, through the communication passage 322.

In the present embodiment, the effects exhibited by the same structure as that in the second embodiment can be obtained in the same manner as the second embodiment.

### Other Embodiments

(1) Although the driver's seat has been described as an example of the front seat 30 in the above-mentioned embodiments, the passenger's seat, or both the driver's seat and the passenger's seat can also be used.
(2) In the description of the above-mentioned second and third embodiments by way of example, the second blowing passage members 51 and 62 are provided in the door 50 and the center pillar 61, respectively, but are not limited thereto. The second blowing passage member 51 may be provided only in the door 50 corresponding to the front seat 30. For example, the second blowing passage member 51 may be provided only in the driver's seat door 50, corresponding to the driver's seat 30a, and the passenger's seat door 50, corresponding to the passenger's seat 30b.
(3) In the description of the above-mentioned respective embodiments, the direction of the front seat 30 is changed by rotating the front seat 30 through the seat rotation mechanism 33, but the changing of the direction of the front seat 30 is not limited thereto. For example, means for changing the direction of the front seat 30 may adopt a transformation mechanism or system that switches the sitting direction by using a mechanism for moving the backrest portion 32 back and forth. The front seat 30 may have its direction changed by modifying the position or shape of the front seat 30.
(4) In the above-mentioned sixth embodiment, the side surface guides 81 and the upper surface guide 82 are attached to the backrest portion 32 of the front seat 30, but are not limited thereto. The side surface guides 81 and the upper surface guide 82 may be formed, for example, integrally with the backrest portion 32 of the front seat 30. The side guides 81 and the upper surface guide 82 may be attached to a vehicle interior component different from the front seat 30, such as a ceiling of the vehicle, or may be formed integrally with a vehicle interior component different from the front seat 30. Specifically, for example, as shown in FIG. 16, the upper surface guide 82 may be attached to a top plate portion 90 of the vehicle, which is a vehicle interior component, via the support portion 82a.
(5) In the description of the above-mentioned respective embodiments by way of example, the vehicle air conditioner is applied to the vehicle that is operable by the autonomous operation system, but is not limited thereto. The vehicle air conditioner can also be applied to, for example, a vehicle that depends on an operation of an occupant.

The present disclosure is not limited to the above-mentioned embodiments, and various modifications and changes can be made to the embodiments. The above-mentioned respective embodiments are not irrelevant to each other, and any combination of the embodiments may be implemented as appropriate except when the combination seems obviously impossible. In the above-mentioned respective embodiments, obviously, components configuring the embodiments are not necessarily essential unless otherwise specified and except when clearly considered to be essential in principle. In the above-mentioned respective embodiments, when referring to a specific number about the components of the embodiments, such as the number, a numerical value, an amount, and a range of the components, these components are not limited to the specific number unless otherwise specified, and except when obviously limited to the specific number in principle. In the above-mentioned respective embodiments, when referring to the material, shape, and positional relationship about the components, the components are not limited to the specific material, shape, positional relationship, or the like which has been referred to, unless otherwise specified and except when obviously limited to the specific material, shape, positional relationship, or the like in principle.

### SUMMARY

According to a first aspect described in a part or all of the above-mentioned respective embodiments, an air conditioner for a vehicle includes an air outlet configured to blow air from an air-conditioning unit. The air conditioner for a vehicle also includes a seat having a seat portion on which an occupant sits and configured to be switchable between a first state in which the occupant sitting on the seat portion faces the front of the vehicle and a second state in which the occupant faces in a different direction from the front of the vehicle. Further, the air conditioner for a vehicle includes a blowing passage member defining a blowing passage that guides the air blown from the air outlet to the occupant sitting on the seat portion when the seat is in the second state.

According to a second aspect described in a part or all of the above-mentioned respective embodiments, an air conditioner for a vehicle includes an air-conditioning unit and an air outlet configured to blow air from the air-conditioning unit. Further, the air conditioner for a vehicle includes a blowing passage member defining a blowing passage that guides the air blown from the air outlet to an upper side of the seat portion when the seat is in the second state.

According to a third aspect, the seat is at least one of a driver's seat or a passenger's seat, and the air outlet is provided at a front side of the vehicle with respect to the seat. In this way, the air conditioner for a vehicle can be applied to the vehicle provided with the air outlet at the front of the vehicle with respect to the seat.

According to a fourth aspect, the seat includes a backrest portion configured to support an upper body of the occupant, and the blowing passage member has a first seat opening provided at a back surface of the backrest portion. Further, the blowing passage member includes: a second seat opening provided at a position different from the first seat opening, in the backrest portion; and a communication passage defined within the backrest portion and configured to communicate between the first seat opening and the second seat opening.

Thus, the blowing passage member can be configured by the first seat opening, the second seat opening, and the communication passage, which are provided in the backrest portion.

According to a fifth aspect, the second opening is provided in a surface of the backrest portion.

According to a sixth aspect, the second opening is provided at a side of an end in a vehicle width direction of the surface of the backrest portion. Therefore, the second seat opening can be prevented from being covered by the body of the occupant.

According to a seventh aspect, the blowing passage member includes: a first blowing passage member provided in the seat; and a second blowing passage member provided in a vehicle interior component that is different from the seat. The blowing passage member is configured to guide the air blown from the air outlet to the occupant via the first blowing passage member and the second blowing passage member when the seat is in the second state.

Thus, when the seat is in the second state, the air blown from the air outlet can be guided to the occupant via the first blowing passage member provided in the seat and the second blowing passage member provided in a vehicle interior component that is different from the seat.

According to an eighth aspect, the second blowing passage member is formed in a door corresponding to the seat. Thus, the second blowing passage member can be formed in the door corresponding to the seat.

According to a ninth aspect, the second blowing passage member is formed in a center pillar of the vehicle. Thus, the second blowing passage member can also be formed in the center pillar of the vehicle.

According to a tenth aspect, the second blowing passage member is formed in a center console of the vehicle. Thus, the second blowing passage member can also be formed in the center console of the vehicle.

According to an eleventh aspect, the first blowing passage member includes: a first seat opening provided at a back surface of a backrest portion; and a second seat opening provided at a position different from the first seat opening in the backrest portion. Further, the first blowing passage member includes a first communication passage defined within the backrest portion and configured to communicate between the first seat opening and the second seat opening.

Meanwhile, the second blowing passage member includes: a first opening provided in the vehicle interior component that is different from the seat; and a second opening provided at a position different from the first opening. Further, the second blowing passage member includes: a second communication passage defined within the vehicle interior component and configured to communicate between the first opening and the second opening.

The first blowing passage member and the second blowing passage member are disposed such that the air blown from the second seat opening flows into the first opening when the seat is in the second state.

Thus, if the first blowing passage member and the second blowing passage member are disposed such that the air blown from the second seat opening flows into the first opening when the seat is in the second state, the air blown from the air outlet can be guided to the occupant.

According to a twelfth aspect, the air conditioner for a vehicle includes a coupling member that couples the second seat opening with the first opening when the seat is in the second state. Therefore, when the seat is in the second state, the whole air blown from the second seat opening can be caused to flow into the first opening.

According to a thirteenth aspect, the air conditioner for a vehicle includes a guide that guides the air blown from the air outlet to the occupant such that the air flows bypassing a backrest portion configured to support an upper body of the occupant on the seat, from a back surface of the backrest portion to a surface of the seat when the seat is in a state where the occupant faces a rear of the vehicle.

In this way, the air conditioner is configured to guide the air blown from the air outlet to the occupant by using the guide, so that the air-conditioning can be efficiently performed for the occupant with the simple configuration.

According to a fourteenth aspect, the guide is attached to the seat or integrally formed with the seat. In this way, the guide can also be configured to be attached to the seat, or alternatively, the guide can also be integrally formed with the seat.

According to a fifteenth aspect, the guide is provided in a vehicle interior component that is different from the seat. Thus, the guide can also be provided in the vehicle interior component that is different from the seat.

According to a sixteenth aspect, the air conditioner for a vehicle also includes a state detector configured to detect that the seat is in the second state; and an air-conditioning controller configured to control the air-conditioning unit. Furthermore, the air-conditioning controller controls the air-conditioning unit to guide the air blown from the air outlet toward an upper side of the seat portion via the blowing passage member when the state detector detects that the seat is in the second state.

With this configuration, when the seat is in the second state, the air blown from the air outlet can be blown toward the occupant, regardless of an operation of the occupant, thereby improving the comfort of the interior.

1. An air conditioner for a vehicle, which blows air into a vehicle interior, the air conditioner comprising:
an air outlet configured to blow air from an air-conditioning unit;
a seat having a seat portion on which an occupant sits, the seat being configured to be switchable between a first state in which the occupant sitting on the seat portion faces a front of the vehicle and a second state in which the occupant faces in a different direction from the front of the vehicle; and
a blowing passage member defining a blowing passage that guides the air blown from the air outlet to the occupant sitting on the seat portion when the seat is in the second state,
wherein the air outlet is configured to blow the air from the air outlet directly toward the occupant sitting on the seat portion when the seat is in the first state.

2. An air conditioner for a vehicle to be used in a vehicle that includes a seat configured to be switchable between a first state in which a front end side part of a seat portion is located at a front of the vehicle with respect to a backrest portion, and a second state in which the front end side part of the seat portion is located at a different position from a position of the front end side part in the first state, the air conditioner comprising:
an air-conditioning unit;
an air outlet configured to blow air from the air-conditioning unit; and
a blowing passage member defining a blowing passage that guides the air blown from the air outlet to an upper side of the seat portion when the seat is in the second state,
wherein the air outlet is configured to blow the air from the air outlet directly toward the occupant sitting on the seat portion when the seat is in the first state.

3. The air conditioner for a vehicle according to claim 1, wherein
the seat is at least one of a driver's seat or a front passenger's seat, and
the air outlet is provided at a front side of the vehicle with respect to the seat.

4. The air conditioner for a vehicle according to claim 1, wherein
the blowing passage member includes:
a first seat opening provided at a back surface of a backrest portion in the seat;
a second seat opening provided at a position different from the first seat opening in the backrest portion; and
a communication passage defined within the backrest portion and configured to communicate between the first seat opening and the second seat opening.

5. The air conditioner for a vehicle according to claim 4, wherein
the second seat opening is provided in a surface of the backrest portion.

6. The air conditioner for a vehicle according to claim 4, wherein
the second seat opening is provided at a side of an end in a vehicle width direction of the surface of the backrest portion.

7. The air conditioner for a vehicle according to claim 1, wherein
the blowing passage member includes: a first blowing passage member provided in the seat; and a second blowing passage member provided in a vehicle interior component that is different from the seat, wherein
the blowing passage member guides the air blown from the air outlet to the occupant via the first blowing passage member and the second blowing passage member when the seat is in the second state.

8. The air conditioner for a vehicle according to claim 7, wherein
the second blowing passage member is provided in a door on a side corresponding to the seat.

9. The air conditioner for a vehicle according to claim 7, wherein
the second blowing passage member is provided in a center pillar of the vehicle.

10. The air conditioner for a vehicle according to claim 7, wherein
the second blowing passage member is formed in a center console of the vehicle.

11. The air conditioner for a vehicle according to claim 7, wherein
the first blowing passage member includes:
a first seat opening provided at a back surface of a backrest portion in the seat;
a second seat opening provided at a position different from the first seat opening in the backrest portion; and
a first communication passage defined within the backrest portion and configured to communicate between the first seat opening and the second seat opening,
the second blowing passage member includes:
a first opening provided in the vehicle interior component that is different from the seat;
a second opening provided in the vehicle interior component at a position different from the first opening; and
a second communication passage defined within the vehicle interior component and configured to communicate between the first opening and the second opening, wherein
the first blowing passage member and the second blowing passage member are disposed such that the air blown from the second seat opening flows into the first opening when the seat is in the second state.

12. The air conditioner for a vehicle according to claim 11, further comprising:
a coupling member that couples the second seat opening with the first opening when the seat is in the second state.

13. The air conditioner for a vehicle according to claim 1, further comprising a guide that guides the air blown from the air outlet to the occupant such that the air flows while bypassing a backrest portion that supports an upper body of the occupant on the seat, from a back surface of the backrest portion, to a surface of the seat, when the seat is in a state where the occupant sitting on the seat portion faces a rear of the vehicle in the second state.

14. The air conditioner for a vehicle according to claim 13, wherein
the guide is attached to the seat or integrally formed with the seat.

15. The air conditioner for a vehicle according to claim 13, wherein
the guide is provided in a vehicle interior component that is different from the seat.

16. The air conditioner for a vehicle according to claim 1, further comprising:
a state detector configured to detect that the seat is in the second state; and
an air-conditioning controller configured to control the air-conditioning unit, wherein
the air-conditioning controller controls the air-conditioning unit to guide the air blown from the air outlet toward an upper side of the seat portion via the blowing passage member when the state detector detects that the seat is in the second state.

17. The air conditioner for a vehicle according to claim 2, wherein
the seat is at least one of a driver's seat or a front passenger's seat, and
the air outlet is provided at a front side of the vehicle with respect to the seat.

18. The air conditioner for a vehicle according to claim 2, wherein
the blowing passage member includes:
a first seat opening provided at a back surface of a backrest portion in the seat;
a second seat opening provided at a position different from the first seat opening in the backrest portion; and
a communication passage defined within the backrest portion and configured to communicate between the first seat opening and the second seat opening.

19. The air conditioner for a vehicle according to claim 2, wherein
the blowing passage member includes: a first blowing passage member provided in the seat; and a second blowing passage member provided in a vehicle interior component that is different from the seat, wherein
the blowing passage member guides the air blown from the air outlet to the occupant via the first blowing passage member and the second blowing passage member when the seat is in the second state.

20. The air conditioner for a vehicle according to claim 2, further comprising a guide that guides the air blown from the air outlet to the occupant such that the air flows while bypassing a backrest portion that supports an upper body of the occupant on the seat, from a back surface of the backrest portion, to a surface of the seat, when the seat is in a state where the occupant sitting on the seat portion faces a rear of the vehicle in the second state.
